(19) United States
(12) Patent Application Publication
(10) Pub. No.: US 2023/0101363 A1
(43) Pub. Date: Mar. 30, 2023

(54) COLORING COMPOSITION, AND COLOR FILTER

(71) Applicant: DIC Corporation, Tokyo (JP)

(72) Inventors: Kazushi Suzuki, Sakura-shi (JP); Ryousuke Asami, Sakura-shi (JP)

(73) Assignee: DIC Corporation, Tokyo (JP)

(21) Appl. No.: 17/798,660

(22) PCT Filed: Jun. 10, 2021
(86) PCT No.: PCT/JP2021/022016

§ 371 Date: Aug. 10, 2022

(30) Foreign Application Priority Data
Aug. 13, 2020 (JP) 2020-136651

(51) Int. Cl. C08F 265/06; C08K 3/22; C08K 5/3437; C08K 5/42; C09D 17/00

(52) U.S. Cl. CPC C08F 265/06; C08K 3/22; C08K 5/3437; C08K 5/42; C09D 17/003; C08K 2003/2244

(57) ABSTRACT

A problem to be solved by the present invention is providing a coloring composition containing a perylene-based compound such as C.I. Pigment Violet 29 while achieving high dispersion into a glycol-based solvent, the coloring composition being usable in a display production process without causing insufficient resist curing or a drop in spectral purity. The coloring composition of the present invention contains a sulfonate compound represented by the following formula (1) and C.I. Pigment Violet 29. A-SO₃M.nH₂O Formula (1) [In the formula (1), A represents a hydrocarbon group having 1 to 20 carbon atoms, optionally having within the structure a halogen, a boron, a nitrogen, a sulfur, a phosphorus, or an oxygen, M represents one equivalent of a cation having a valence of 1 to 3 excluding H, and n represents an integer of 0 to 5]

### TECHNICAL FIELD

The present invention relates to a coloring composition and a color filter.

### BACKGROUND ART

In the field of liquid crystal displays, a liquid crystal panel provided with a color filter on array (COA) in which a color filter substrate is integrated with a TFT array substrate has attracted attention. When the COA is used, precise alignment to be performed in the case of using the aforementioned two substrates is not required, and each of red, blue, and green pixels in a color filter can be miniaturized up to the limit, and thus it is possible to obtain a high-definition liquid crystal panel.

Since a resin black matrix for such a COA needs to have high light-blocking properties, it is required that the resin black matrix be made into a thick film. However, as the film thickness of the resin black matrix increases, the difference in the crosslink density of a portion exposed to light in a film thickness direction increases, and thus it is difficult to achieve high sensitization and obtain a black pattern having a good shape. Further, as measures for high light-blocking, attempts have been made to use a large amount of a light-blocking material. However, when a conductive material, such as carbon, is used as the light-blocking material, the specific dielectric constant of the black matrix becomes high, and the volume resistance thereof is lowered, thereby causing a problem of deteriorating the reliability of a display device.

In order to solve such a problem, attempts to use a black organic pigment composition (organic black matrix) obtained by mixing chromatic organic pigments to become black, instead of carbon black as a light-blocking material have been recently actively conducted.

A coloring composition and dispersion liquid for producing the above color filter are described in, for example, Patent Literatures 1 to 4 below. In particular, a combination of perylene and a sulfonic acid derivative of a dye has a high dispersion viscosity. Further, when the derivative is an organic dye derivative, the absorbance in the visible region is high and the hue changes as compared with that of a colorant alone. In addition, there is a problem that the absorbance in the ultraviolet region is high, which inhibits ultraviolet curing.

### CITATION LIST

### Patent Literature

PTL 1: JP-A-2005-213403
PTL 2: JP-A-2002-22922
PTL 3: JP-A-2009-69822
PTL 4: WO 2015/015962A pamphlet

### SUMMARY OF INVENTION

### Technical Problem

As described in the above Patent Literatures 1 to 4, adding a dyeing pigment derivative for the purpose of improving the dispersibility of a poorly dispersible dyeing pigment is a well-known and general-purpose method in the art. However, when a dyeing pigment derivative having high coloring power is added, a decrease in spectral purity becomes a problem. Compared to paints and inkjet applications, dyeing pigments are required to have a higher level of dispersibility in color filter applications and display light-blocking applications

In recent years, there has been a demand for a coloring composition containing a perylene-based compound such as C.I. Pigment Violet 29, which is difficult to highly disperse in a glycol-based solvent used in a production process of light-blocking members for display (black matrix or black column spacer, black bank), while achieving high dispersion into a glycol-based solvent, the coloring composition being capable of being used in a display production process without causing insufficient resist curing or a drop in spectral purity. Therefore, an object of the present invention is to provide a coloring composition and a color filter that can solve the aforementioned problems.

### Solution to Problem

As a result of studies, the inventors of the present invention found that it is possible to improve the dispersibility in C.I. Pigment Violet 29 by using, as a dispersing agent, a compound containing a sulfonate having a significantly lower absorbance in the visible region than a general dyeing pigment derivative such as copper phthalocyanine sulfonic acid used to improve dispersibility.

The inventors of the present invention speculate that the mechanism of the dispersibility improvement is as follows.

Perylene other than C.I. Pigment Violet 29 has a low acidity because its NH part with high acidity is substituted. Therefore, dispersion and viscosity reduction progress by a mechanism in which the matrix of an acidic derivative is adsorbed on perylene and an acidic group is adsorbed on the amine of a dispersant. As a result, there is no excess of acid in the range of normal use (added about 1 to 20%). On the other hand, C. I. Pigment Violet 29 has a highly acidic imide moiety N—H and acts directly with the dispersant amine. Therefore, when an acidic sulfonic acid derivative is added, the acid becomes excessive. From the viewpoint of the balance of acid-base in a dispersion system, when the acid is excessive, the aggregation of the pigment is promoted and the viscosity increases. On the other hand, when the basic dispersant is excessive, the viscosity increases due to the entanglement of dispersant polymers. Therefore, the sulfonate in the C.I. Pigment Violet 29 dispersion system can prevent the viscosity from being increased due to the entanglement of the dispersant molecules by acting with the excess amine without increasing the acidity in the system.

That is, the present invention is as follows.

Item 1. A coloring composition containing a sulfonate compound represented by the following formula (1) and C.I. Pigment Violet 29.

A-SO₃M.nH₂O Formula (1)

[In the formula (1), A represents a hydrocarbon group having 1 to 20 carbon atoms, optionally having within its structure a halogen, a boron, a nitrogen, a sulfur, a phosphorus, or an oxygen, M represents one equivalent of a cation having a valence of 1 to 3 excluding H, and n represents an integer of 0 to 5]
Item 2. The coloring composition according to Item 1, wherein an aqueous solution of a sulfonate compound obtained by mixing 0.5 parts of a sulfonate compound represented by the following formula (1) with 10 parts of pure water having a pH of 6 to 8 has a pH of 2 to 12, and a maximum absorbance in a wavelength range of 380 to 780 nm measured in accordance with JISK 0115:2004 is 10% or less of a maximum absorbance of C.I. Pigment Violet 29.

A-SO₃M.nH₂O Formula (1)

[In the formula (1), A represents a hydrocarbon group having 1 to 20 carbon atoms, optionally having within its structure a halogen, a boron, a nitrogen, a sulfur, a phosphorus, or an oxygen, M represents one equivalent of a cation having a valence of 1 to 3 excluding H, and n represents an integer of 0 to 5]
Item 3. The coloring composition according to Item 2, wherein the aqueous solution of the sulfonate compound has a pH of 6 to 11.
Item 4. The coloring composition according to any one of Items 1 to 3, wherein the sulfonate compound represented by the formula (1) is at least one sulfonate compound selected from benzene sulfonate, toluene sulfonate, naphthalene sulfonate, anthraquinone sulfonate, 2-morpholinoalkyl sulfonate, allyl sulfonate, (±)-10-camphor sulfonate, linear alkyl sulfonate, and branched alkyl sulfonate.
Item 5. The coloring composition according to any one of Items 1 to 4, wherein the sulfonate compound represented by the formula (1) is at least one compound selected from a group consisting of a compound represented by the following formulae (1-1) to (1-10),

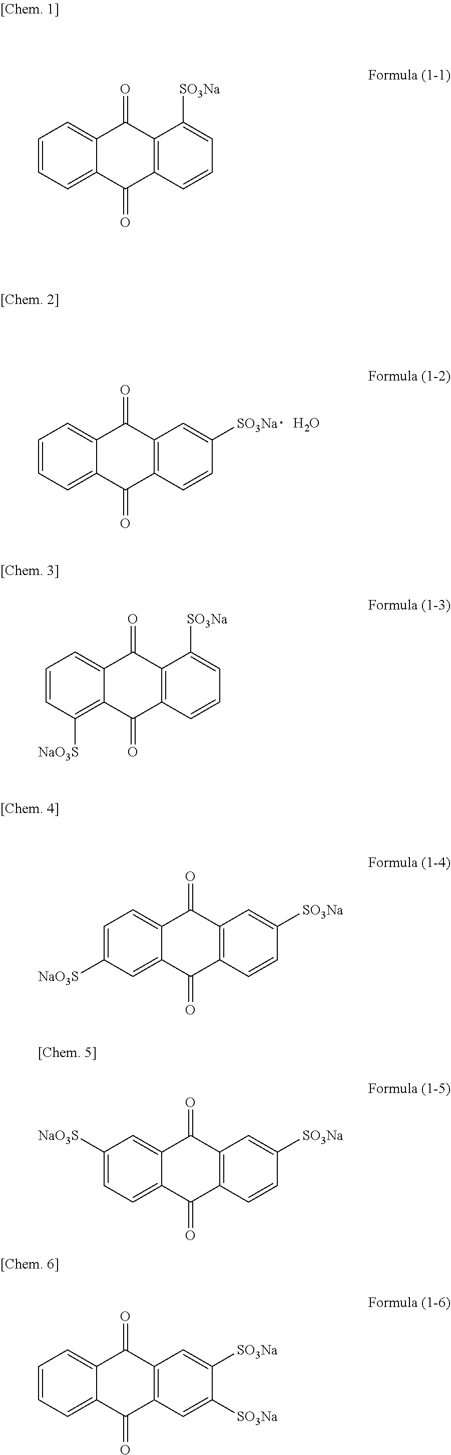

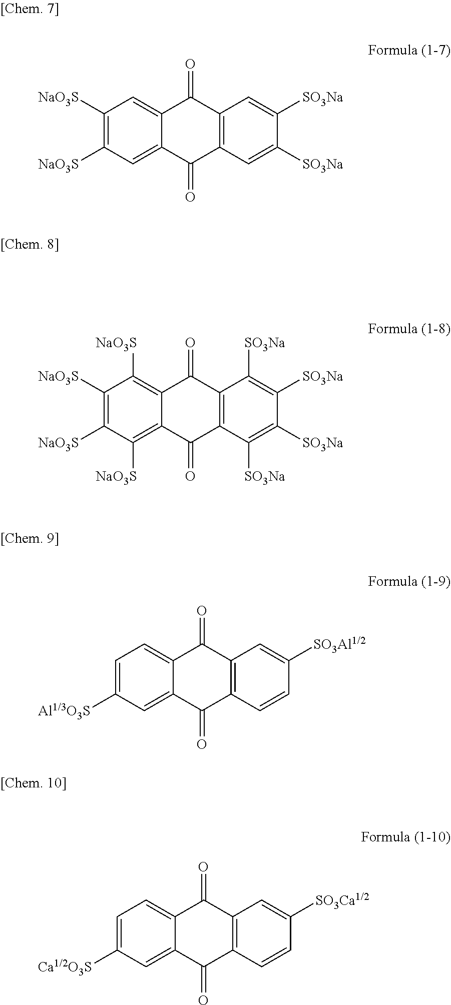

sodium 2-naphthalene sulfonate, sodium 2-morpholinoethane sulfonate, sodium p-toluene sulfonate, potassium methanesulfonate, sodium 3-mercapto-1-propane sulfonate, sodium allyl sulfonate, sodium (±)-10-camphor sulfonate, and sodium 1-decanesulfonate.
Item 6. A color filter containing the coloring composition according to any one of Items 1 to 5.

### Advantageous Effects of Invention

In the coloring composition of the present invention, by combining C.I. Pigment Violet 29 and a non-dye-based sulfonate, a dispersion liquid having a particularly low viscosity can be obtained as compared with a combination of C.I. Pigment Violet 29 and a sulfonic acid derivative of a dye. In addition, compared with a combination of a sulfonate and perylene other than C.I. Pigment Violet 29, the effect of reducing the viscosity when sulfonate is added is greater. Since the coloring composition of the present invention uses a non-dye-based sulfonate derivative having a small absorbance in the visible region, the change from the hue of the colorant alone is small even after the derivative is added. Moreover, since the absorbance in the ultraviolet region is small, it does not inhibit ultraviolet curing.

### DESCRIPTION OF EMBODIMENTS

### [Coloring Composition]

The coloring composition of the present invention contains a sulfonate compound represented by the following formula (1) and C.I. Pigment Violet 29 (hereinafter referred to as “PV 29”).

A-SO₃M.nH₂O Formula (1)

[In the formula (1), A represents a hydrocarbon group having 1 to 20 carbon atoms, optionally having within its structure a halogen, a boron, a nitrogen, a sulfur, a phosphorus, or an oxygen, M represents one equivalent of a cation having a valence of 1 to 3 excluding H, and n represents an integer of 0 to 5]

Examples of the halogen, which is A in the formula (1), include a fluorine atom, a chlorine atom, a bromine atom, and an iodine atom. Examples of the hydrocarbon group having 1 to 20 carbon atoms include an aromatic hydrocarbon group having 6 to 20 carbon atoms such as benzene, toluene, xylene, naphthalene and anthraquinone, and a linear or branched alkyl group having 1 to 12 carbon atoms. Examples of the cation having a valence of 1 to 3 excluding H, which is M, include lithium, sodium, potassium, calcium, magnesium, titanium, chromium, aluminum, manganese, iron, copper, nickel, silver, gold, lead, and tin.

The sulfonate compound represented by the formula (1) is preferably at least one sulfonate compound selected from benzene sulfonate, toluene sulfonate, naphthalene sulfonate, anthraquinone sulfonate, 2-morpholinoalkyl sulfonate, allyl sulfonate, (±)-10-camphor sulfonate, linear alkyl sulfonate, and branched alkyl sulfonate. By acting with excess amine without increasing the acidity in the system, these sulfonate compounds can prevent the increase in viscosity due to the entanglement of the dispersant molecules, and can be dispersion liquids having a particularly low viscosity.

Further, the sulfonate compound represented by the formula (1) is preferably at least one compound selected from a group consisting of a compound represented by the following formulae (1-1) to (1-10),

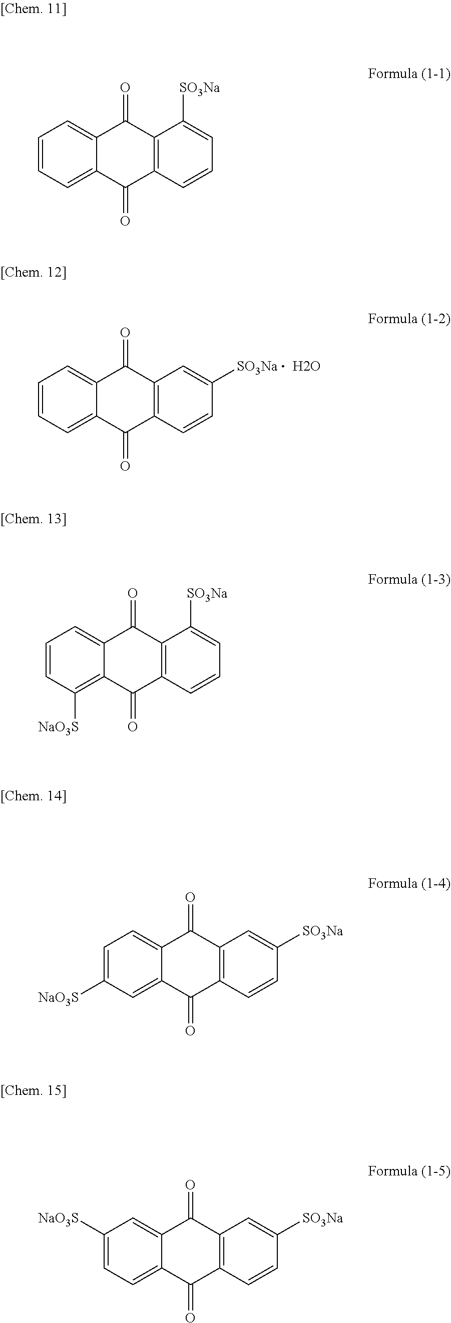

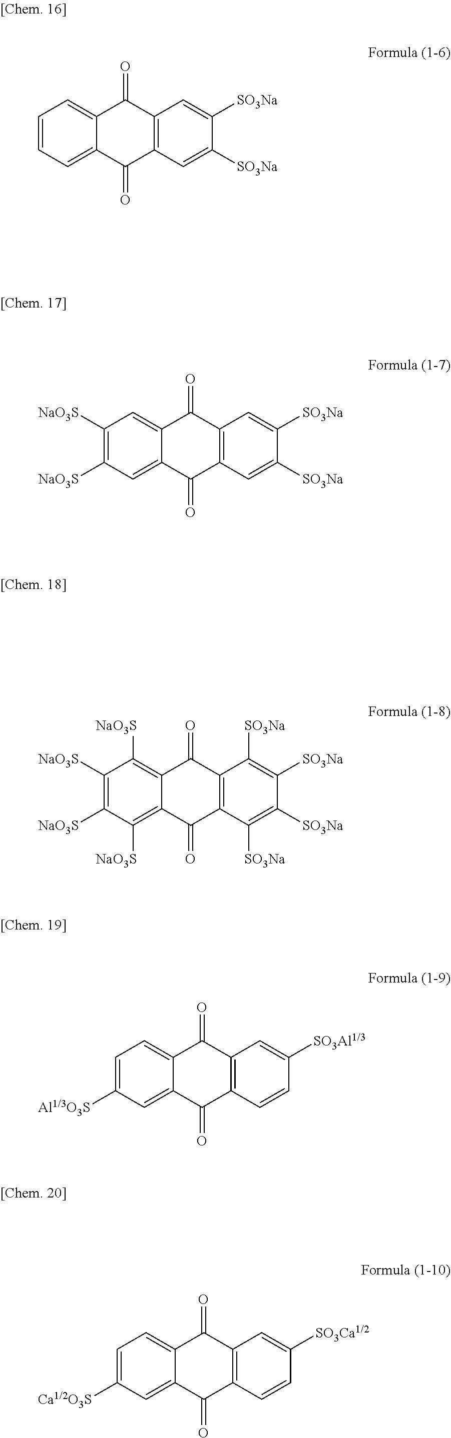

sodium 2-naphthalene sulfonate, sodium 2-morpholinoethane sulfonate, sodium p-toluene sulfonate, potassium methanesulfonate, sodium 3-mercapto-1-propane sulfonate, sodium allyl sulfonate, sodium (±)-10-camphor sulfonate, and sodium 1-decanesulfonate.

In the coloring composition of the present invention, the ratio of the sulfonate compound represented by the formula (1) is, for example, 0.5 to 20 parts by mass, preferably 1 to 5 parts by mass with respect to 100 parts by mass of PV 29.

The coloring composition of the present invention may contain a perylene-based organic pigment other than PV 29. Examples of the perylene-based organic pigment include C.I. Pigment Red 123, C.I. Pigment Red 149, C.I. Pigment Red 178, C.I. Pigment Red 179, C.I. Pigment Red 189, C.I. Pigment Red 190, C.I. Pigment Red 224, C.I. Pigment Red 228, C.I. Pigment Black 31, and C.I. Pigment Black 32.

Further, in addition to the aforementioned perylene-based organic pigment, other organic pigments may be used in combination from the viewpoint of imparting light-blocking properties. Examples of these organic pigments include blue organic pigments, yellow organic pigments, and red organic pigments. Based on the chemical structure, examples of the organic pigments of various colors include azo-based, phthalocyanine-based, quinacridone-based, benzimidazolone-based, isoindolinone-based, dioxazine-based, indanthrone-based, and perylene-based organic pigments. Specific examples of pigments that can be used in the present invention are shown below by pigment numbers.

Examples of the blue organic pigment include C.I. Pigment Blue 1, 1:2, 9, 14, 15, 15:1, 15:2, 15:3, 15:4, 15:6, 16, 17, 19, 25, 26, 27, 28, 29, 33, 35, 36, 56, 56:1, 60, 61, 61:1, 62, 63, 64, 66, 67, 68, 71, 72, 73, 74, 75, 76, 78, 79, and 80. Among these, C.I. Pigment Blue 15, 15:1, 15:2, 15:3, 15:4, 15:6, 25, 26, 60 and 80 are preferable, and C.I. Pigment Blue 15:6, 25, 26, 60 and 80 are more preferable.

Examples of the yellow organic pigment include C.I. Pigment Yellow 1, 1:1, 2, 3, 4, 5, 6, 9, 10, 12, 13, 14, 16, 17, 24, 31, 32, 34, 35, 35:1, 36, 36:1, 37, 37:1, 40, 41, 42, 43, 48, 53, 55, 61, 62, 62:1, 63, 65, 73, 74, 75, 81, 83, 87, 93, 94, 95, 97, 100, 101, 104, 105, 108, 109, 110, 111, 116, 117, 119, 120, 126, 127, 127:1, 128, 129, 133, 134, 136, 138, 139, 142, 147, 148, 150, 151, 153, 154, 155, 157, 158, 159, 160, 161, 162, 163, 164, 165, 166, 167, 168, 169, 170, 172, 173, 174, 175, 176, 180, 181, 182, 183, 184, 185, 188, 189, 190, 191, 191:1, 192, 193, 194, 195, 196, 197, 198, 199, 200, 202, 203, 204, 205, 206, 207, 208, and 229. Among these, C.I. Pigment Yellow 83, 117, 129, 138, 139, 150, 154, 155, 180, 185 and 229 are preferable, and C.I. Pigment Yellow 83, 138, 139, 150, 180, 185 and 229 are more preferable.

Examples of the red organic pigment include C.I. Pigment Red 1, 2, 3, 4, 5, 6, 7, 8, 9, 12, 14, 15, 16, 17, 21, 22, 23, 31.32, 37, 38, 41, 47, 48, 48:1, 48:2, 48:3, 48:4, 49, 49:1, 49:2, 50:1, 52:1, 52:2, 53, 53:1, 53:2, 53:3, 57, 57:1, 57:2, 58:4, 60, 63, 63:1, 63:2, 64, 64:1, 68, 69, 81, 81:1, 81:2, 81:3, 81:4, 83, 88, 90:1, 101, 101:1, 104, 108, 108:1, 109, 112, 113, 114, 122, 123, 144, 146, 147, 149, 151, 166, 168, 169, 170, 172, 173, 174, 175, 176, 177, 178, 179, 181, 184, 185, 187, 188, 190, 193, 194, 200, 202, 206, 207, 208, 209, 210, 214, 216, 220, 221, 224, 230, 231, 232, 233, 235, 236, 237, 238, 239, 242, 243, 245, 247, 249, 250, 251, 253, 254, 255, 256, 257, 258, 259, 260, 262, 263, 264, 265, 266, 267, 268, 269, 270, 271, 272, 273, 274, 275 and 276. Among these, C.I. Pigment Red 48:1, 122, 168, 177, 202, 206, 207, 209, 224, 242 and 254 are preferable, and C.I. Pigment Red 177, 209, 224 and 254 are more preferable.

The primary particle size of the pigment in the coloring composition of the present invention such as PV 29 is, for example, 20 to 150 nm, and is preferably 20 to 100 nm from the viewpoint of imparting high light-blocking properties. When the primary particle size of the pigment exceeds 150 nm, the dispersion stability deteriorates, and as a result, light scattering may easily occur.

The primary particle size of the pigment in the coloring composition of the present invention means that, after the coloring composition is dispersed in a solvent such as cyclohexanone, the dispersion liquid is applied on a colloidal film, and an image under a scanning electron microscope (TEM) is taken, the sizes of 1000 particles of the obtained photographed image are measured and the average value is used as the primary particle size of the pigment.

Pigment miniaturization is conducted by a pulverization method such as dry pulverization and wet pulverization as roughly classified. However, as carried out in the present invention, solvent salt milling, which is kneading for a long time, is suitable from the viewpoint of high inorganic salt ratio with respect to the pigment.

In the present invention, if necessary, a green organic pigment, a purple organic pigment, an orange organic pigment, a brown organic pigment, or the like may be used in combination to adjust the color tone. As the other-color organic pigments used in combination, it is preferable to use a pigment having an average primary particle size of 20 to 100 nm.

Examples of suitable organic pigments having colors other than blue, yellow, and red for use in combination include C.I. Pigment Green 7, 36, 58, 62 and 63, C.I. Pigment Orange 13, 36, 38, 60, 62, 64, 71 and 72, and C.I. Pigment Violet 19, 23 and 37.

The organic pigment and the combination thereof to be used may be any colors as long as the blackness required for a target black matrix can be obtained. Making black by subtractively mixing the three primary colors, i.e., blue, yellow, and red, belongs to the common general knowledge of those skilled in the art, and the mixing ratio thereof is not particularly limited. However, for example, when the total of each color organic pigment of blue, yellow, and red is set to 100% in terms of mass, black can be adjusted by increasing or decreasing each color by plus or minus 7%, centering on 33% of each color on a mass basis.

When these organic pigment compositions are dispersed in an organic solvent, a resin-based dispersant may be used in order to improve dispersibility and dispersion stability. The resin-based dispersant has a function of being bonded to an organic pigment and an anchoring site to allow a compatible portion to be extended in a dispersion medium so as to constitute a dispersion, and is different in kind from an alkali-soluble resin or a photopolymerizable monomer used in the preparation of a photosensitive composition to be described later.

Examples of the resin-based dispersant include resin-based dispersants having a polymer chain, such as a polyurethane resin, polyethyleneimine, polyoxyethylene glycol diester, an acrylic resin, and a polyester resin. Among these, a polyester resin-based dispersant and/or an acrylic resin-based dispersant is preferable in terms of dispersibility, heat resistance, and light resistance.

Specific examples of the various types of resin-based dispersant include AJISPER (manufactured by Ajinomoto Fine-Techno Co., Inc.), EFKA (manufactured by BASF), DISPERBYK (manufactured by BYK Company), BYKLPN (manufactured by BYK Company), DISPARLON (manufactured by Kusumoto Chemicals, Ltd.), SOLSPERSE (manufactured by Lubrizol Corporation), KP (manufactured by Shin-Etsu Chemical Co., Ltd.), and POLYFLOW (manufactured by KYOEISHA CHEMICAL Co., LTD.). These dispersants may be used singly, and two or more kinds thereof can be used in any combination and in any ratio.

The content of the resin-based dispersant is generally 30 parts to 60 parts, and preferably 38 parts to 50 parts per 100 parts, based on mass, of the sum of organic pigments of respective colors.

Generally, an organic solvent is used in the preparation of the coloring composition of the present invention.

Examples of the organic solvent include diisopropyl ether, mineral spirit, n-pentane, amyl ether, ethyl caprylate, n-hexane, diethyl ether, isoprene, ethyl isobutyl ether, butyl stearate, n-octane, BARSOL #2, APCO #18 solvent, diisobutylene, amyl acetate, butyl acetate, APCO thinner, butyl ether, diisobutyl ketone, methyl cyclohexene, methyl nonyl ketone, propyl ether, dodecane, SOKAL solvent No. 1 and No. 2, amyl formate, dihexyl ether, diisopropyl ketone, SOLVESSO #150, (n, sec, t-) butyl acetate, hexene, shell TS28 solvent, butyl chloride, ethyl amyl ketone, ethyl benzoate, amyl chloride, ethylene glycol diethyl ether, ethyl ortho formate, methoxy methylpentanone, methyl butyl ketone, methyl hexyl ketone, methyl isobutyrate, benzonitrile, ethyl propionate, methyl cellosolve acetate, methyl isoamyl ketone, n-amyl methyl ketone (2-heptanone), methyl isobutyl ketone, propyl acetate, amyl acetate, amyl formate, bicyclohexyl, diethylene glycol monoethyl ether acetate, dipentene, methoxymethyl pentanol, methyl amyl ketone, methyl isopropyl ketone, propyl propionate, propylene glycol-t-butyl ether, methyl ethyl ketone, methyl cellosolve, ethyl cellosolve, ethyl cellosolve acetate, carbitol, cyclohexanone, ethyl acetate, propylene glycol, propylene glycol monomethyl ether, propylene glycol monomethyl ether acetate, propylene glycol monoethyl ether, propylene glycol monoethyl ether acetate, dipropylene glycol monoethyl ether, dipropylene glycol dimethyl ether, dipropylene glycol monomethyl ether, dipropylene glycol monomethyl ether acetate, 3-methoxy propionate, 3-ethoxypropionate, methyl 3-ethoxypropionate, ethyl 3-ethoxypropionate, methyl 3-methoxypropionate, ethyl 3-methoxy propionate, propyl 3-methoxy propionate, butyl 3-methoxy propionate, diglyme, ethylene glycol acetate, ethyl carbitol, butyl carbitol, ethylene glycol monobutyl ether, propylene glycol-t-butyl ether, 3-methoxy butanol, 3-methyl-3-methoxy butanol, and tripropylene glycol methyl ether.

When a photosensitive composition for forming a black matrix by photolithography is prepared using the coloring composition, in order for the photosensitive composition to be excellent in coatability, workability, an dischargeability in low viscosity, it is preferable that at least propylene glycol monomethyl ether acetate is used as an organic solvent to be contained in the coloring composition.

In order to prepare the coloring composition, the organic solvent may be used singly, and two or more kinds thereof can be used in any combination and in any ratio. However, in the coloring composition of the present invention, the content of the organic solvent is generally 300 parts to 800 parts, and preferably 400 parts to 600 parts per 100 parts, based on mass, of the sum of the organic pigments of respective colors.

In the preparation of the coloring composition, if necessary, for example, various kinds of pigment derivatives can be used in combination. Examples of the substituents of the pigment derivative include a sulfonic acid group, a sulfonamide group and a quaternary salt thereof, a phthalimidemethyl group, a dialkylaminoalkyl group, a hydroxyl group, a carboxyl group, and an amide group, each of which is directly bonded to a pigment skeleton or is bonded to a pigment skeleton through an alkyl group, an aryl group, a heterocyclic group, or the like.

The coloring composition can be prepared by mixing and stirring the above-described organic pigment compositions of respective colors, a resin-based dispersant, and an organic solvent. When necessary, the coloring composition can be prepared by performing shaking over the required time in the presence of various grinding media, such as beads or rods, and dispersing the media by filtration or the like.

The coloring composition of the present invention can be used in forming a black matrix portion by a conventionally known method.

A typical method of preparing a color filter is a photolithography method. In the photolithography, a black matrix is obtained by a method including the steps of: applying the following photosensitive composition prepared from the coloring composition of the present invention onto a transparent substrate for a color filter; heating and drying (prebaking) the applied photosensitive composition; performing pattern exposure by irradiating the prebaked photosensitive composition with ultraviolet light through a photomask to cure a photocurable compound of a portion corresponding to a black matrix portion; and developing an unexposed portion with a developer and removing a non-pixel portion to fix a pixel portion to the transparent substrate. In the method, a black matrix portion composed of the cured colored film of the photosensitive composition is formed on the transparent substrate. Each pixel portion of RGB can also be formed from the photosensitive composition prepared from organic pigments of respective colors having a larger specific surface area similarly to the above-described manner.

Examples of the method of applying the photosensitive composition to be described later onto a transparent substrate, such as a glass substrate include a spin coating method, a roll coating method, a slit coating method, and an ink jet method.

The drying conditions of the coating film of the photosensitive composition applied on the transparent substrate are changed depending on the kind of each component, a combination ratio, and the like, but are generally at 50° C. to 150° C. for about 1 to 15 minutes. The heat treatment is generally referred to as a “prebake”. Further, as the light used in the photocuring of the photosensitive composition, ultraviolet light having a wavelength range of 200 nm to 500 nm or visible light is preferable. Various light sources emitting the light having the wavelength range can be used.

Examples of the developing method include a puddle method, a dipping method, and a spray method. After the exposure and development of the photosensitive composition, the transparent substrate, on which a black matrix or a pixel portion having necessary colors is formed, is washed with water and dried. The color filter obtained in this way is heat-treated (post-baked) by a heating device, such as a hot plate or an oven, at 100° C. to 280° C. for a predetermined time to remove volatile components in the colored coating film and to thermally cure the unreacted photocurable compound remaining in the cured colored film of the photosensitive composition, thereby completing the color filter.

The photosensitive composition for forming a black matrix portion of a color filter can be prepared by mixing essential components including the coloring composition of the present invention, an alkali-soluble resin, a photopolymerizable monomer, and a photopolymerization initiator.

When the colored resin film for forming a black matrix portion needs toughness capable of withstanding baking performed in the actual production of a color filter, in order to prepare the photosensitive composition, it is essential that not only the polymerizable monomer but also the alkali-soluble resin is used in combination. When the alkali-soluble resin is used in combination, an organic solvent capable of dissolving the alkali-soluble resin is preferably used.

As the method of preparing the photosensitive composition, a method of previously preparing the coloring composition of the present invention and then adding an alkali-soluble resin, a photopolymerizable monomer, and a photopolymerization initiator thereto to obtain a photosensitive composition is generally used.

Examples of the alkali-soluble resin used in the preparation of the photosensitive composition include resins containing a carboxyl group or a hydroxyl group exhibiting acidity, such as a novolak type phenol resin, a (meth)acrylic acid alkyl ester-(meth)acrylic acid copolymer, a styrene-(meth)acrylic acid copolymer, and a styrene-maleic acid copolymer. In the present invention, the term “(meth)acrylic” collectively refers to acrylic and methacrylic. Among them, in order to further increase the heat resistance of the cured film, it is preferable to use an alkali-soluble resin containing each polymerization unit of an imide structure, styrene, and (meth)acrylic acid.

Unlike the above-described resin, the alkali-soluble resin does not have a function of being bonded to an organic pigment and an anchoring site to allow a compatible portion to be extended in a dispersion medium so as to constitute a dispersion. However, on the other hand, the alkali-soluble resin is exclusively used in order to remove the unexposed portion of the photosensitive composition by taking advantage of its characteristics of dissolving when coining into contact with alkali.

Examples of the photopolymerizable monomer include di-functional monomers, such as 1,6-hexanediol di(meth)acrylate, ethylene glycol di(meth)acrylate, neopentyl glycol di(meth)acrylate, triethylene glycol di(meth)acrylate, bis[(meth)acryloxyethoxy] bisphenol A, and 3-methyl-pentanediol di(meth)acrylate; multi-functional monomers having a relatively small molecular weight, such as trimethylolpropane tri(meth)acrylate, pentaerythritol tri(meth)acrylate, tris(2-hydroxyethyl)isocyanurate tri(meth)acrylate, dipentaerythritol hexa(meth)acrylate, dipentaerythritol penta(meth)acrylate, and ditrimethylolpropane tetra(meth)acrylate; and multi-functional monomers having a relatively large molecular weight, such as polyester acrylate, polyurethane acrylate, and polyether acrylate. Similarly to the above description, the term “(meth)acrylate” collectively refers to acrylate and methacrylate.

Among them, in order to further increase the heat resistance of the cured film, it is preferable to use tetra-functional to hexa-functional (meth)acrylates.

Examples of the photopolymerization initiator include acetophenone, benzophenone, benzyl dimethyl ketanol, benzoyl peroxide, 2-chloro thioxanthone, 1,3-bis(4′-azidebenzal)-2-propane, 1,3-bis(4-azidebenzal)-2-propane-2′-sulfonic acid, 4,4′-diazidestilbene-2,2′-disulfonic acid, and ethanone-1-[9-ethyl-6-[2-methyl-4-(2,2-dimethyl-1,3-dioxolanyl)methoxybenzoyl]-9H-carbazol-3-yl]-1-(O-acetyloxime).

When an alkali-soluble resin not affecting light transmittance and a photopolymerizable monomer are selected, the cured film of the photosensitive composition can have a maximum light transmittance of 1% or less in a wavelength range of 400 nm to 800 nm and a light transmittance of 80% in a near-infrared region having a wavelength range of 800 nm to 1100 nm, which are suitable for a black matrix.

The light transmittance of a black matrix refers to light transmittance of a black matrix (cured film) having a film thickness of 3 μm formed on a transparent substrate, such as a glass substrate, measured by using a spectrophotometer, in comparison to the substrate on which a resin black matrix is not formed.

The maximum light transmittance means the greatest value in the light transmittance in a specific wavelength region (range). More specifically, the maximum light transmittance is the maximum value of a light transmittance curve in a specific wavelength region. For example, the case where “the maximum light transmittance in a wavelength range of 400 nm to 800 nm is 1% or less” means that the maximum value of a light transmittance curve in a wavelength range of 400 nm to 800 nm is 1% or less, and there is no region of which light transmittance is more than 1% in this range.

On the other hand, the “wavelength 800 nm to 1100 nm” means a so-called near-infrared region. The “black matrix having a light transmittance of 80% or more in the near-infrared region of wavelength of 800 nm to 1100 nm refers to a black matrix having low light absorptivity and high light transmittance in the near-infrared wavelength region. The higher the light transmittance in the near-infrared region, it is the easier for the black matrix to dissipate the heat generated from a TFT element which is a heat generating source. Therefore, an increase in on-current and off-current in the TFT element is also reduced, and it is difficult to cause a thermal runaway.

Further, when the volume resistivity is set to 1×10¹³ Ω·cm or more and the dielectric constant is set to 5 or less, the short circuit of the TFT element (switching element composed of a thin film transistor) due to leakage current can be reduced, the switching of the TFT element can be accurately transferred, and the disturbance of driving of liquid crystal can also be reduced.

The volume resistivity is a criterion of insulation properties of a material, and is electrical resistance per unit volume. For example, the volume resistivity can be measured by a method described in the “University Lectures of the Institute of Electrical Engineers of Japan, Electrical and electronic material—from the basic to the test method—” from the Institute of Electrical Engineers of Japan (pages 223 to 230, 2006, Ohmsha, Ltd.).

The dielectric constant means a so-called specific permittivity, and is a ratio of the dielectric constant of a material and the dielectric constant of vacuum. For example, the dielectric constant can be measured by a method described in the “University Lectures of the Institute of Electrical Engineers of Japan, Electrical and electronic material—from the basic to the test method—” from the Institute of Electrical Engineers of Japan (pages 233 to 243, 2006, Ohmsha, Ltd.).

With respect to the photosensitive composition of the present invention having such characteristics, 3 parts to 20 parts of the sum of an alkali-soluble resin and a photopolymerizable monomer per 100 parts of the coloring composition of the present invention, 0.05 parts to 3 parts of a photopolymerization initiator per 1 part of the photopolymerizable monomer, and, if necessary, the organic solvent used in the preparation of the above-described coloring composition are added and stirred to be dispersed uniformly, so that a photosensitive composition for forming a black matrix portion can be obtained.

In the formation of a black matrix by photolithography, in order for the photosensitive composition of the present invention to have a low viscosity which brings about excellent coatability and workability, it is preferable to prepare the photosensitive composition such that, at least, the content of non-volatile components is from 5% to 20% based on mass.

As the developer, it is possible to use a commonly known alkali aqueous solution. Particularly, since the photosensitive composition contains an alkali-soluble resin, the washing with the alkali aqueous solution is effective in the formation of a black matrix portion. The excellent heat resistance of the photosensitive composition of the present invention is exhibited in the method of preparing a color filter in which baking is performed after such alkali washing.

Although the method of preparing a black matrix portion by photolithography has been described in detail with respect to a pigment dispersion method, a color filter may be prepared in such a manner that the black matrix portion to be prepared using the photosensitive composition of the present invention is formed by other methods, such as an electrodeposition method, a transfer method, a micelle electrolysis method, and a photovoltaic electrodeposition (PVED) method.

The color filter can be obtained by a method in which the photosensitive compositions of respective colors obtained by using a red organic pigment, a green organic pigment, a blue organic pigment, and the coloring composition of the present invention is used, the space between a pair of transparent electrodes in parallel to each other is sealed with a liquid crystal material, each of the transparent electrodes is divided into discontinuous fine sections, and simultaneously color filter colored pixel portions having any one color selected from red (R), green (G), and blue (B) are alternately provided in a pattern in each of the fine sections divided in a reticular pattern by a black matrix on the transparent electrode, or can be obtained by a method in which transparent electrodes are provided after color filter colored pixel portions are formed on a substrate.

The black matrix portion obtained from the photosensitive composition of the present invention is configured to contain the above-described blue, yellow, and red organic pigments to appear black. At first glance, it is presumed to obtain a black matrix similar to the case of preparing a black photosensitive composition by mixing photosensitive compositions of respective colors. However, in the present invention, at the time of preparing a coloring composition, which is a previous step of forming a photosensitive composition, organic pigments of respective colors are mixed in advance, and, as a result, more uniform mixing is achieved, and a black matrix having superior characteristics is obtained.

The coloring composition of the present invention is preferably a sulfonate compound, where the pH of an aqueous solution of a sulfonate compound obtained by mixing 0.5 parts of the sulfonate compound represented by the formula (1) with 10 parts of pure water having a pH of 6 to 8 is 2 to 12, and the maximum absorbance in a wavelength range of 380 to 780 nm measured in accordance with JISK 0115:2004 is 10% or less of the maximum absorbance of PV 29. Further, the pH of the aqueous solution of the sulfonate compound is preferably 6 to 11 from the viewpoint of obtaining a dispersion liquid having a particularly low viscosity.

The pH of the aqueous solution of the sulfonate compound can be measured using a pH meter in accordance with JIS Z 8802: 2011. Further, the maximum absorbance in the wavelength range of 380 to 780 mu is a relative value when the absorption spectrum is measured with a spectrophotometer in accordance with JIS K 0115: 2004 and the peak top absorbance of the absorption spectrum of an aqueous solution obtained by mixing 0.5 parts of C.I. Pigment Violet 29 and 10 parts of pure water is set to 100.

The acidity of the pigment can be measured by, after mixing and stirring about 0.1 g of a sample with a 0.001N tetrabutylammonium hydroxide (TBAH)/n-propyl acetate (NPAC) solution (or 15 ml of 0.001 N p-toluenesulfonic acid (PTSA)/NPAC solution) using a rotating revolution stirrer, centrifuging to precipitate the pigment and measuring the amount of unadsorbed acid-base in 10 ml of a supernatant by potentiometric titration using 0.001N PTSA/NPAC (or TBAH/NPAC solution). Further, the pigment adsorption amount can be calculated by subtracting the aforementioned unadsorbed amount from the added amount. A value obtained by dividing the base adsorption amount by the acid adsorption amount is defined as a colorant acid-base adsorption amount ratio, and it is determined that the larger the value is, the higher the acidity

The dispersion liquid containing the coloring composition of the present invention is obtained by using PV 29 and the sulfonate compound represented by the formula (1) as essential components, adding an organic solvent such as propylene glycol monomethyl ether acetate and a dispersant such as a basic resin type dispersant, adding zirconia beads, and dispersing using a paint conditioner. The viscosity of the dispersion liquid is, for example, 1 to 100 mPa·s, preferably 3 to 20 mPa·s. The viscosity of the dispersion liquid can be measured using an E-type viscometer.

A cured coating film of the color filter can be prepared by mixing the dispersion liquid, an alkali-soluble resin, a photopolymerizable monomer, a photopolymerization initiator, and an organic solvent to form a photosensitive resin composition and producing according to a standard method for producing a black matrix.

### EXAMPLES

Hereinafter, the present invention will be described in more detail based on Examples. However, the present invention is not limited to the following Examples. In the Examples, “part” represents “part by mass”.

### Example 1

### <Preparing Process of Coloring Composition>

0.2 mmφ to 0.3 mmφ of zirconia beads were added to a mixture of 17 parts of Paliogen Red Violet K 5411 (colorant, C.I. Pigment Violet 29 manufactured by BASF), 44 parts of BYK LPN-21116 (basic acrylic resin type dispersant, manufactured by BYK Company), 2 parts of sodium 2-naphthalene sulfonate (additive, manufactured by Fujifilm Wako Pure Chemical Industries, Ltd.), and 218 parts of propylene glycol monomethyl ether acetate (organic solvent, manufactured by Kuraray Trading Co., Ltd.), followed by dispersing with a paint conditioner (manufactured by Toyo Seiki Co., Ltd.) for two hours to obtain a coloring composition (A-1).

### <Preparing Process of Photosensitive Resin Composition>

100 parts of the coloring composition (A-1), 5 parts of a methacrylic acid/mono(2-methacryloyloxyethyl) succinate/N-phenylmaleimide/styrene/benzyl methacrylate copolymer (copolymerization mass ratio=25/10/30/20/15, Mw=12,000, Mn=6,500) as an alkali-soluble resin, 10 parts of dipentaerythritol hexaacrylate as a photopolymerizable monomer, 1 part of ethanone-1-[9-ethyl-6-[2-methyl-4-(2,2-dimethyl-1,3-dioxolanyl)-methoxybenzoyl]-9H-carbazol-3-yl]-1-(O-acetyloxime) as a photopolymerization initiator, and 25 parts of dipropylene glycol dimethyl ether, 25 parts of propylene glycol monomethyl ether acetate, 75 parts of 3-methoxy-butyl acetate, and 50 parts of cyclohexanone, as an organic solvent, were mixed, so as to obtain a photosensitive resin composition (B-1).

### <Preparing Process of Cured Pattern>

A glass substrate of 10 cm square (glass plate “OA-10” for color filter, manufactured by Nippon Electric Glass Co., Ltd.) was dipped into a solution of a silane coupling agent “KBM-603” (manufactured by Shin-Etsu Chemical Co., Ltd.) which is diluted to 1%, for 3 minutes, washed with water for 10 seconds, water-drained by an air gun, and then dried in an oven at 110° C. for 5 minutes. The photosensitive resin composition (B-1) prepared as above was applied onto the glass substrate using a spin coater. The applied photosensitive resin composition (B-1) was vacuum-dried for 1 minute, and then heated and dried on a hot plate at 90° C. for 90 seconds, so as to obtain a coating film having a dried film thickness of about 3.5 μm. Thereafter, from the side of the coating film, image exposure was carried out through a fine line pattern mask having a width of 15 μm. The exposure was performed under a condition of using a 3 kw high-pressure mercury lamp at 50 mJ/cm² (i-line reference). Next, shower development was carried out under a water pressure of 0.15 Mpa at 23° C. using a developer composed of an aqueous solution containing 0.05% of potassium hydroxide and 0.08% of a nonionic surfactant (“A-60”, manufactured by Kao Corporation), the development was stopped with pure water, and then washing was carried out by a water-washing spray, so as to obtain a cured pattern (C-1). Here, the shower development time was adjusted between 10 seconds and 120 seconds, and was 1.5 times the time taken to dissolve and remove the unexposed coating film.

### <pH and Absorbance of Additive>

0.5 parts of the additive and 10 parts of pure water (using 2 μS/cm or less and pH: 7.0±1.0) were mixed. The pH was measured using a pH meter (PH71, manufactured by Yokogawa Electric Corporation) in accordance with JIS Z 8802: 2011. The absorption spectrum of the aqueous solution in the wavelength range of 380 to 780 nm was measured with a spectrophotometer (U3900, manufactured by Hitachi High-Tech Science Corporation), in accordance with JISK 0115:2004 and Table 1 below shows the absorbance when the peak top absorbance of the absorption spectrum of a dispersion liquid obtained by mixing 0.5 parts of Paliogen Red Violet K 5411 (colorant, C.I. Pigment Violet 29 manufactured by BASF) and 10 parts of pure water (using 2 μS/cm or less and pH: 7.0±1.0) was set to 100.

### Example 2

A coloring composition (A-2) was obtained in the same manner as in Example 1, except that the additive of Example 1 was changed to 2 parts of sodium p-toluene sulfonate (additive, manufactured by Tokyo Chemical Industry Co., Ltd.). A cured pattern (C-2) was obtained in the same manner as in Example 1, except that the coloring composition (A-1) was changed to the coloring composition (A-2).

### Example 3

A coloring composition (A-3) was obtained in the same manner as in Example 1, except that the additive of Example 1 was changed to 2 parts of sodium allylsulfonate (additive, manufactured by Fujian Wako Pure Chemical Industries, Ltd.). A cured pattern (C-3) was obtained in the same manner as in Example 1, except that the coloring composition (A-1) was changed to the coloring composition (A-3).

### Example 4

A coloring composition (A-4) was obtained in the same manner as in Example 1, except that the additive of Example 1 was changed to 2 parts of potassium methanesulfonate (additive, manufactured by Tokyo Chemical Industry Co., Ltd.). A cured pattern (C-4) was obtained in the same manner as in Example 1, except that the coloring composition (A-1) was changed to the coloring composition (A-4).

### Example 5

A coloring composition (A-5) was obtained in the same manner as in Example 1, except that the additive of Example 1 was changed to 2 parts of sodium 2-morpholinoethane sulfonate (additive, manufactured by Tokyo Chemical Industry Co., Ltd.). A cured pattern (C-5) was obtained in the same manner as in Example 1, except that the coloring composition (A-1) was changed to the coloring composition (A-5).

### Example 6

A coloring composition (A-6) was obtained in the same manner as in Example 1, except that the additive of Example 1 was changed to 2 parts of sodium 3-mercapto-1-propane sulfonate (additive, manufactured by Tokyo Chemical Industry Co., Ltd.). A cured pattern (C-6) was obtained in the same manner as in Example 1, except that the coloring composition (A-1) was changed to the coloring composition (A-6).

### Example 7

A coloring composition (A-7) was obtained in the same manner as in Example 1, except that the additive of Example 1 was changed to 2 parts of sodium (±)-10-camphor sulfonate (additive, manufactured by Tokyo Chemical Industry Co., Ltd.). A cured pattern (C-7) was obtained in the same manner as in Example 1, except that the coloring composition (A-1) was changed to the coloring composition (A-7).

### Example 8

A coloring composition (A-8) was obtained in the same manner as in Example 1, except that the additive of Example 1 was changed to 2 parts of sodium 1-decanesulfonate (additive, manufactured by Tokyo Chemical Industry Co., Ltd.). A cured pattern (C-8) was obtained in the same manner as in Example 1, except that the coloring composition (A-1) was changed to the coloring composition (A-8).

### Example 9

A coloring composition (A-9) was obtained in the same manner as in Example 1, except that the additive of Example 1 was changed to 2 parts of sodium anthraquinone-2-sulfonate monohydrate (additive, manufactured by Tokyo Chemical Industry Co., Ltd.). A cured pattern (C-9) was obtained in the same manner as in Example 1, except that the coloring composition (A-1) was changed to the coloring composition (A-9).

### Example 10

A coloring composition (A-10) was obtained in the same manner as in Example 1, except that the additive of Example 1 was changed to 2 parts of sodium anthraquinone-2,6-disulfonate (additive, manufactured by Tokyo Chemical Industry Co., Ltd.). A cured pattern (C-10) was obtained in the same manner as in Example 1, except that the coloring composition (A-1) was changed to the coloring composition (A-10).

### Comparative Example 1

A coloring composition (A-11) was obtained in the same manner as in Example 1, except that the additive of Example 1 was not added. A cured pattern (C-11) was obtained in the same manner as in Example 1, except that the coloring composition (A-1) was changed to the coloring composition (A-11).

### Comparative Example 2

A coloring composition (A-12) was obtained in the same manner as in Example 1, except that the colorant of Example 1 was changed to 17 parts of PALIOGEN RED L3880 HD (colorant, C.I. Pigment Red 178 manufactured by BASF) and the additive was not added. A cured pattern (C-12) was obtained in the same manner as in Example 1, except that the coloring composition (A-1) was changed to the coloring composition (A-12).

### Comparative Example 3

A coloring composition (A-13) was obtained in the same manner as in Example 1, except that the colorant of Example 1 was changed to 17 parts of 229-6438 (colorant, C.I. Pigment Red 179 manufactured by SUN CHEMICAL COMPANY LTD.) and the additive was not added. A cured pattern (C-13) was obtained in the same manner as in Example 1, except that the coloring composition (A-1) was changed to the coloring composition (A-13).

### Comparative Example 4

A coloring composition (A-14) was obtained in the same manner as in Example 1, except that the colorant of Example 1 was changed to 17 parts of PALIOGEN RED L3880 HD (colorant, C.I. Pigment Red 178 manufactured by BASF). A cured pattern (C-14) was obtained in the same manner as in Example 1, except that the coloring composition (A-1) was changed to the coloring composition (A-14).

### Comparative Example 5

A coloring composition (A-15) was obtained in the same manner as in Example 1, except that the colorant of Example 1 was changed to 17 parts of 229-6438 (colorant, C.I. Pigment Red 179 manufactured by SUN CHEMICAL COMPANY LTD.). A cured pattern (C-15) was obtained in the same manner as in Example 1, except that the coloring composition (A-1) was changed to the coloring composition (A-15).

### Comparative Example 6

A coloring composition (A-16) was obtained in the same manner as in Example 1, except that the additive of Example 1 was changed to 2 parts of 2-naphthalene sulfonic acid (additive, manufactured by Tokyo Chemical Industry Co., Ltd.). A cured pattern (C-16) was obtained in the same manner as in Example 1, except that the coloring composition (A-1) was changed to the coloring composition (A-16).

### Comparative Example 7

A coloring composition (A-17) was obtained in the same manner as in Example 1, except that the additive of Example 1 was changed to 2 parts of p-toluenesulfonic acid monohydrate (additive, manufactured by Fujifilm Wako Pure Chemical Industries, Ltd.). A cured pattern (C-17) was obtained in the same manner as in Example 1, except that the coloring composition (A-1) was changed to the coloring composition (A-17).

### Comparative Example 8

A coloring composition (A-18) was obtained in the same manner as in Example 1, except that the additive of Example 1 was changed to 2 parts of SOLSPERSE 12000 (additive, manufactured by Lubrizol Corporation). A cured pattern (C-18) was obtained in the same manner as in Example 1, except that the coloring composition (A-1) was changed to the coloring composition (A-18).

### <Evaluation>

Acidity of Pigment (Acid-Base Adsorption Ratio)

The acidity was measured by, after mixing and stirring about 0.1 g of a pigment with a 0.001N tetrabutylammonium hydroxide (TBAH)/n-propyl acetate (NPAC) solution or 15 ml of 0.001 N p-toluenesulfonic acid (PTSA)/NPAC solution using a rotating revolution stirrer (Awatori Rentaro, manufactured by Thinky Corporation) for 3 minutes, centrifuging (11,000 rpm, 20 minutes) to precipitate the pigment and measuring the amount of unadsorbed acid-base in 10 ml of a supernatant by potentiometric titration (COM-1700, manufactured by Hiranuma Co., Ltd.) using 0.001N PTSA/NPAC or TBAH/NPAC solution. The acid-base adsorption amount to the pigment was calculated by subtracting the aforementioned unadsorbed amount from the added amount. A value obtained by dividing the base adsorption amount by the acid adsorption amount was defined as a colorant acid-base adsorption amount ratio, and it was determined that the larger the value, the higher the acidity. It was found that PV 29 had much higher acidity than C.I. Pigment Red 178 (PR178) and C.I. Pigment Red 179 (PR179), which were also perylenes.

Viscosity

As the viscosities of the coloring compositions (A-1) to (A-18) obtained in Examples 1 to 10 and Comparative Examples 1 to 8, values of 30 rpm were measured with an E-type viscometer (TVE-25L, manufactured by Toki Sangyo Co., Ltd.). In a viscosity system 1 using PV 29 as the colorant, the value of Comparative Example 1 was converted into 100 and shown in the table below. In a viscosity system 2 using PR178 as the colorant, the value of Comparative Example 2 was converted into 100 and shown in Table 1 below. In a viscosity system 3 using PR179 as the colorant, the value of Comparative Example 3 was converted into 100 and shown in Table 1 below.

Curing Extent

Results of visually determining the presence and absence of pattern defects in the cured patterns (C-1) to (C-10), (C-11), (C-16) to (C-18) obtained in Examples 1 to 10, Comparative Example 1, and Comparative Examples 6 to 8 (curing extent “A” for those without defects, curing extent “B” for those with defects) are shown in Table 1 below as the extent of curing.

Spectral Purity

The absorption spectrums of the cured patterns (C-1) to (C-10), (C-11), (C-16) to (C-18) obtained in Examples 1 to 10, Comparative Example 1, and Comparative Examples 6 to 8 were measured with a spectrophotometer (U3900, manufactured by Hitachi High-Tech Science Corporation), and those without an absorption peak other than PV 29 showing an intensity of 3% or more of the peak top absorbance of the absorption spectrum in the wavelength range of 380 to 780 inn are shown as “A” and those with such absorption peak as “B” in Table 1 below.

TABLE 1

| | | Acid-base | | | | | | | | |
|---|---|---|---|---|---|---|---|---|---|---|
| | | (adsorption | | Additive | Additive | Viscosity | | | Curing | Spectral |
| | Colorant | amount ratio) | Additive | pH | absorbance | System 1 | System 2 | System 3 | extent | purity |
| Ex. 1 | PV29 | 7.6 | Sodium 2-naphthalene | 9.2 | 1 | 45 | — | — | A | A |
| | | | sulfonate | | | | | | | |
| Ex. 2 | PV29 | 7.6 | Sodium p-toluene sulfonate | 3 | 1 | 60 | — | — | A | A |
| Ex. 3 | PV29 | 7.6 | Sodium allyl sulfonate | 3.9 | 1 | 70 | — | — | A | A |
| Ex. 4 | PV29 | 7.6 | Potassium methanesulfonate | 10.6 | 1 | 50 | — | — | A | A |
| Ex. 5 | PV29 | 7.6 | Sodium 2-morpolinoethane | 9.4 | 1 | 50 | — | — | A | A |
| | | | sulfonate | | | | | | | |
| Ex. 6 | PV29 | 7.6 | Sodium 3-mercapto-1-propane | 2.2 | 1 | 60 | — | — | A | A |
| | | | sulfonate | | | | | | | |
| Ex. 7 | PV29 | 7.6 | Sodium (±)-10-camphor | 7.3 | 1 | 80 | — | — | A | A |
| | | | sulfonate | | | | | | | |
| Ex. 8 | PV29 | 7.6 | Sodium 1-decanesulfonate | 9.5 | 1 | 85 | — | — | A | A |
| Ex. 9 | PV29 | 7.6 | Sodium anthraquinone- | 6.8 | 4 | 45 | — | — | A | A |
| | | | 2-sulfonate monohydrate | | | | | | | |
| Ex. 10 | PV29 | 7.6 | Sodium anthraquinone- | 7.9 | 5 | 85 | — | — | A | A |
| | | | 2,6-disulfonate | | | | | | | |
| Comp. | PV29 | 7.6 | — | — | — | 100 | — | — | A | A |
| Ex. 1 | | | | | | | | | | |
| Comp. | PR178 | 0.6 | — | — | — | — | 100 | — | — | — |
| Ex. 2 | | | | | | | | | | |
| Comp. | PR179 | 1.9 | — | — | — | — | — | 100 | — | — |
| Ex. 3 | | | | | | | | | | |
| Comp. | PR178 | 0.6 | Sodium 2-naphthalene | 9.2 | 1 | — | 100 | — | — | — |
| Ex. 4 | | | sulfonate | | | | | | | |
| Comp. | PR179 | 1.9 | Sodium 2-naphthalene | 9.2 | 1 | — | — | 95 | — | — |
| Ex. 5 | | | sulfonate | | | | | | | |
| Comp. | PV29 | 7.6 | 2-naphthalene sulfonic | 0.7 | 1 | >400 | — | — | A | A |
| Ex. 6 | | | acid | | | | | | | |
| Comp. | PV29 | 7.6 | p-toluenesulfonic acid | 0.9 | 1 | >400 | — | — | A | A |
| Ex. 7 | | | monohydrate | | | | | | | |
| Comp. | PV29 | 7.6 | S12000* | 1.5 | 110 | 90 | — | — | B | B |
| Ex. 8 | | | | | | | | | | |

*S12000: SOLSPERSE 12000 (copper phthalocyanine sulfonic acid, manufactured by Lubrizol Corporation)

Examples 1 to 10, in which PV 29 and a non-dye-based sulfonate having a pH of 2 to 12 when an aqueous solution was prepared were combined, can obtain a dispersion liquid having a lower viscosity as compared with Comparative Example 1, in which no additive was added, and Comparative Example 8, in which PV 29 and a sulfonic acid derivative of a dye such as copper phthalocyanine sulfonic acid were combined. Further, comparing Example 1 and Comparative Example 1, Comparative Example 2 and Comparative Example 4, Comparative Example 3 and Comparative Example 5, it can be seen that Example 1 has a greater effect of reducing the viscosity when the sulfonate is added as compared with Comparative Example 4 and Comparative Example 5 in which a sulfonate and perylene other than PV 29 were combined. In addition, it can be seen that in Examples 1 to 10, in which a non-dye-based sulfonate derivative is added, the curing extent and spectral purity can be maintained even after the addition of the derivative as compared with that in Comparative Example 8, in which a sulfonic acid derivative of a dye such as copper phthalocyanine sulfonic acid was added.

1. A coloring composition containing a sulfonate compound represented by the following formula (1) and C.I. Pigment Violet 29.
A-SO₃M.nH₂O Formula (1)
[In the formula (1), A represents a hydrocarbon group having 1 to 20 carbon atoms, optionally having within its structure a halogen, a boron, a nitrogen, a sulfur, a phosphorus, or an oxygen, M represents one equivalent of a cation having a valence of 1 to 3 excluding H, and n represents an integer of 0 to 5]

2. The coloring composition according to claim 1, wherein an aqueous solution of a sulfonate compound obtained by mixing 0.5 parts of a sulfonate compound represented by the following formula (1) with 10 parts of pure water having, a pH of 6 to 8 has a pH of 2 to 12, and a maximum absorbance in a wavelength range of 380 to 780 inn measured in accordance with JISK 0115:2004 is 10% or less of a maximum absorbance of C.I. Pigment Violet 29.
A-SO₃M.nH₂O Formula (1)
[In the formula (1), A represents a hydrocarbon group having 1 to 20 carbon atoms, optionally having within its structure a halogen, a boron, a nitrogen, a sulfur, a phosphorus, or an oxygen, M represents one equivalent of a cation having a valence of 1 to 3 excluding H, and 11 represents an integer of 0 to 5]

3. The coloring composition according to claim 2, wherein the aqueous solution of the sulfonate compound has a pH of 6 to 11.

4. The coloring composition according to claim 1, wherein the sulfonate compound represented by the formula (1) is at least one sulfonate compound selected from benzene sulfonate, toluene sulfonate, naphthalene sulfonate, anthraquinone sulfonate, 2-morpholinoalkyl sulfonate, allyl sulfonate, (±)-10-camphor sulfonate, linear alkyl sulfonate, and branched alkyl sulfonate.

5. The coloring composition according to claim 1, wherein the sulfonate compound represented by the formula (1) is at least one compound selected from a group consisting of a compound represented by the following formulae (1-1) to (1-10), 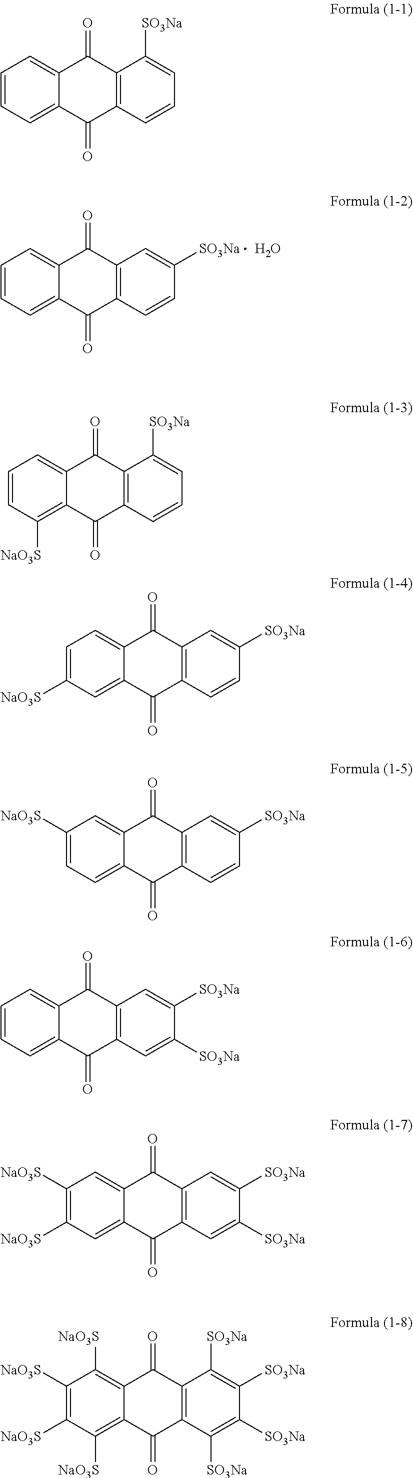 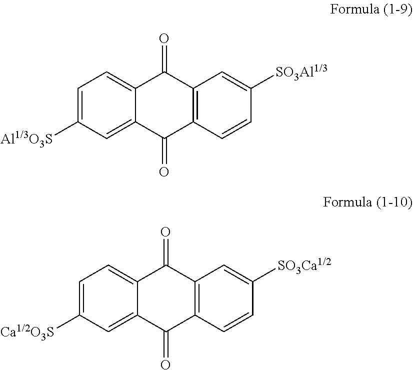
sodium 2-naphthalene sulfonate, sodium 2-morpholinoethane sulfonate, sodium p-toluene sulfonate, potassium methanesulfonate, sodium 3-mercapto-1-propane sulfonate, sodium allyl sulfonate, sodium (±)-10-camphor sulfonate, and sodium 1-decanesulfonate.

6. A color filler containing the coloring composition according to claim 1.
